(19) United States
(12) Patent Application Publication
(10) Pub. No.: US 2016/0373049 A1
(43) Pub. Date: Dec. 22, 2016

(54) APPARATUS FOR CONTROLLING MOTOR

(71) Applicants: HYUNDAI MOTOR COMPANY, Seoul (KR); KIA MOTORS CORPORATION, Seoul (KR)

(72) Inventors: Gyeong Cheol KIM, Hwaseong-si (KR); Hak Sung LEE, Gunpo-si (KR); Seong Hwan KIM, Hwaseong-si (KR); Sang Lok SONG, Hwaseong-si (KR)

(21) Appl. No.: 14/918,171

(22) Filed: Oct. 20, 2015

(30) Foreign Application Priority Data
Jun. 17, 2015 (KR) 10-2015-0086112

(51) Int. Cl. H02P 29/02; H02P 6/12; G01D 5/14

(52) U.S. Cl. CPC H02P 29/022; G01D 5/142; H02P 6/12

(57) ABSTRACT

An apparatus for controlling a motor includes a hall sensor including a plurality of phases, each phase provided to output hall signals depending on a driving state of the motor, a micom for detecting a failure of the hall sensor based on the hall signals and output virtual hall signals which are the hall signals in a normal condition depending on the detected results, and a motor controller for receiving the hall signals from the hall sensor or the virtual hall signals from the micom and drive the motor depending on the received signal.

### CROSS REFERENCE TO RELATED APPLICATION

The present application claims the benefit of priority to Korean Patent Application No. 10-2015-0086112, filed Jun. 17, 2015 with the Korean Intellectual Property Office, the entirety of which is incorporated herein by reference.

### TECHNICAL FIELD

The present disclosure relates to an apparatus for controlling a motor that is capable of normally driving a motor at the time of a failure of a hall sensor.

### BACKGROUND

Generally, an electric oil pump (EOP) includes a brushless DC motor (BLDC motor). The brushless motor is developed to keep characteristics of a three-phase DC motor while removing a brush serving as a commutator in a general three-phase DC motor and includes a rotor which is formed of a permanent magnet and a stator around which U-phase, V-phase, and W-phase coils are wound.

The brushless motor supplies a three-phase current to each of the U-phase, V-phase, and W-phase coils wound around the stator and allows each of the U-phase, V-phase, and W-phase coils to generate a magnetic field depending on the supplied three-phase current to rotate the rotor, which is formed of the permanent magnet.

To accurately control a rotating speed of the rotor of the brushless motor, there is a need to accurately estimate a position of the rotor. A hall sensor is generally used for this purpose. The hall sensor is used to measure a rotating position and direction of the motor using a hall effect. The hall sensor may detect a relative position of the rotor to the stator based on the magnetic field generated by the permanent magnet of the rotor.

However, when the hall sensor does not function properly, the position of the rotor may not be normally detected. For example, a waveform is normally generated in a half period of one period of an output signal from the hall sensor which is in a failure condition, but a waveform of which the phase mismatches is generated in the remaining half period, such that a driving voltage depending on a wrong output signal is applied to the motor. Next, a current conducted to the motor is increased or noise and vibration of the motor are increased and the rotation of the motor is likely to be instable.

When the brushless motor is abnormally operated due to the failure of the hall sensor, the electric oil pump may not smoothly form an oil pressure, such that a vehicle may not be driven.

The matters described as the related art have been provided only for assisting in the understanding for the background of the present disclosure and should not be considered as corresponding to the related art known to those skilled in the art.

### SUMMARY OF THE DISCLOSURE

An object of the present disclosure is to provide an apparatus for controlling a motor capable of increasing system efficiency at the time of a normal condition by receiving a virtual hall signal using a micom only at the time of a failure of a hall sensor.

According to an exemplary embodiment of the present disclosure, there is provided an apparatus for controlling a motor, including: a hall sensor including a plurality of phases, each phase provided to output hall signals depending on a driving state of the motor; a micom for detecting a failure of the hall sensor based on the hall signals and output virtual hall signals which are the hall signals in a normal condition depending on the detected results; and a motor controller for receiving the hall signals from the hall sensor or the virtual hall signals from the micom and drive the motor depending on the received signal.

The apparatus may further includes a switch for keeping a first state in which the micom and the motor controller are disconnected each from other and the hall sensor and the motor controller are connected to each other, wherein when detecting the failure of the hall sensor, the micom may switch the switch from the first state to a second state in which the micom and the motor controller are connected to each other and the hall sensor and the motor controller are disconnected from each other.

The motor controller may receive the virtual hall signal from the micom when the switch is in the second state and may directly receive the hall signals from the hall sensor when the switch is in the first state.

When detecting the failure of the hall sensor, the micom may output the virtual hall signal for a broken phase and the hall signal for a normal phase, among the plurality of phases.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are diagrams illustrating an apparatus for controlling a motor according to an exemplary embodiment of the present disclosure.

### DETAILED DESCRIPTION

Hereinafter, an apparatus for controlling a motor according to an exemplary embodiment of the present disclosure will be described with reference to the accompanying drawings.

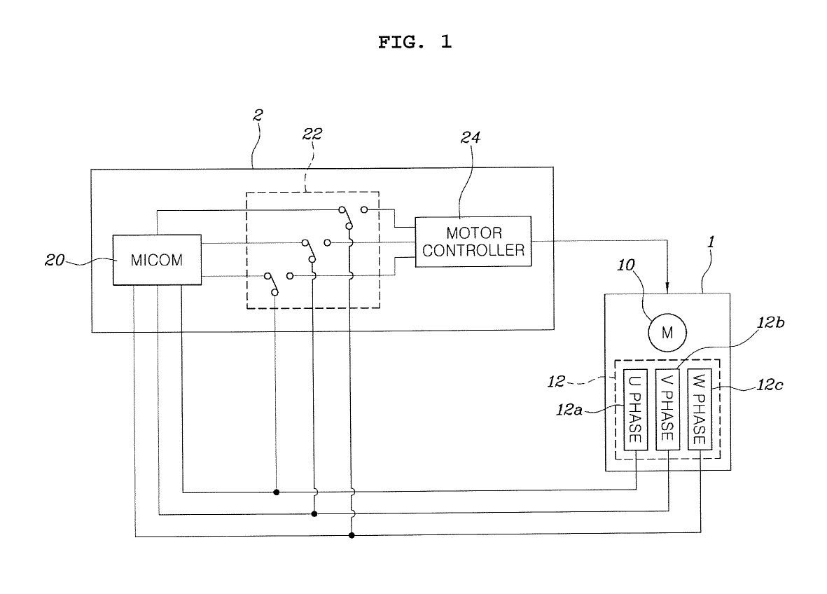

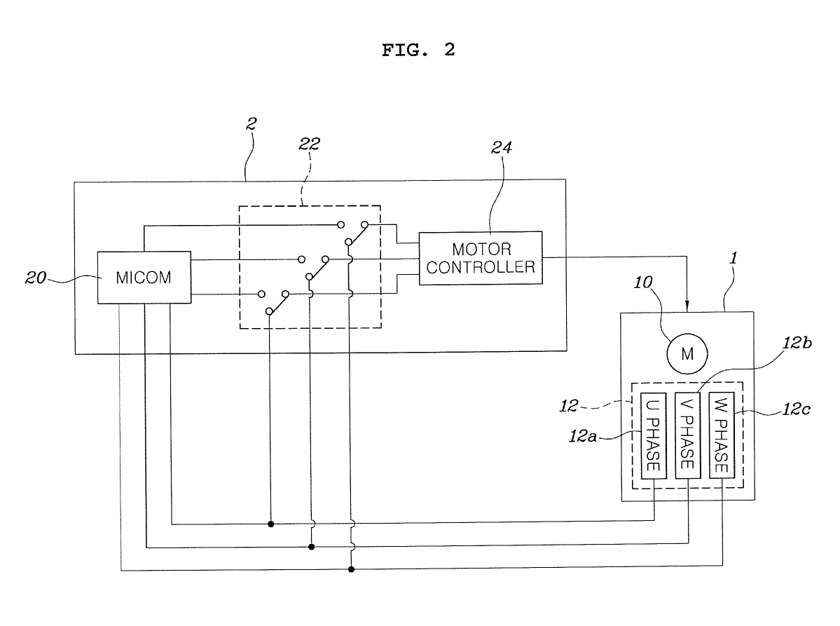

FIGS. 1 and 2 are diagrams illustrating an apparatus for controlling a motor according to an exemplary embodiment of the present disclosure. Referring to FIGS. 1 and 2, the apparatus for controlling a motor may include a hall sensor 12 which includes a plurality of phases 12a, 12b, and 12c, each provided to output hall signals depending on a driving state of a motor 10, a micom 20 which detects a failure of the hall sensor 12 based on the hall signals and outputs virtual hall signals which are the hall signals in a normal condition depending on the detected results, and a motor controller 24 which receives the hall signals from the hall sensor 12 or the virtual hall signals from the micom 20 and drives the motor 10 depending on the received signal.

The motor 10 and the hall sensor 12 are included in an electric oil pump 1, and the micom 20 and the motor controller 24 may be included in an oil pump unit (OPU).

The plurality of phases 12a, 12b, and 12c of the hall sensor 12 output PWM waveforms which are the hall signals depending on the driving of the motor. In the normal condition, the plurality of phases 12a, 12b, and 12c output the hall signals of which the electrical angles are crossed at an interval of 60°.

However, when at least one of the plurality of phases 12a, 12b, and 12c of the hall sensor 12 gets out of order, the phase in the failure condition outputs a hall signal of 0 or 1 at a time. Therefore, when all of the plurality of phases 12a, 12b, and 12c output the hall signal of 0 or 1, the micom 20 may detect that the hall sensor 12 is in the failure condition. That is, when all the hall signals output from the plurality of phases 12a, 12b, and 12c are 0 or 1, the micom 20 detects that the hall sensor 12 is in the failure condition and diagnoses which of the plurality of phases 12a, 12b, and 12c gets out of order based on the received hall signal.

When the micom 20 diagnoses which phase gets out of order based on the hall signal, the virtual hall signal for the broken phase is output to the motor controller 24. In this case, the virtual hall signal is a hall signal in a normal condition. Therefore, the motor controller 24 may normally drive the motor 10 based on the received virtual hall signal.

For example, when a U phase 12a of the plurality of phases gets out of order, the U phase 12a outputs a signal of 0 or 1 at a time independent of a period. Therefore, the micom 20 receives PWM waveforms of 0, 0, 0 or 1, 1, 1, as the hall signal output from the hall sensor 12 and detects the failure of the hall sensor 12. Next, when the U phase 12a gets out of order, to continuously drive the motor 10, the hall signal, that is, the virtual hall signal when the U phase 12a is in a normal condition, is output to the motor controller 24, and thus the motor controller 24 continuously drives the motor 10. In addition, even when the V phase 12b, the W phase 12c, or the plurality of phases get out of order, the motor 10 may be continuously driven as described above.

Meanwhile, the motor controller 24 may receive the hall signals from the plurality of phases 12a, 12b, and 12c or the micom 20, depending on whether the hall sensor 12 gets out of order.

That is, when the hall sensor 12 outputs the hall signals due to the failure, the hall signal is output to the micom 20 and the motor controller 24 may receive the virtual hall signals from the micom 20 to continuously drive the motor 10. On the contrary, when the hall sensor 12 outputs the hall signal in the normal condition, the hall signal is directly output to the motor controller 24, such that the motor controller 24 may directly control the motor 10 depending on the hall signal. As a result, a delay time occurring by passing the hall signal through the micom 20 may be reduced and the system efficiency between the electric oil pump 1 and the oil pump unit 2 may be increased.

In detail, the apparatus for controlling a motor further includes a switch 22 which keeps a first state in which the micom 20 and the motor controller 24 are disconnected from each other, and the hall sensor 12 and the motor controller 24 are connected to each other. When detecting the failure of the hall sensor 12, the micom 20 switches the switch 22 from the first state to a second state in which the micom 20 and the motor controller 24 are connected to each other and the hall sensor 12 and the motor controller 24 are disconnected from each other.

Here, the switch 22 may be provided in plural, corresponding to the phases 12a, 12b, and 12c as illustrated in FIGS. 1 and 2, and may be operated to be simultaneously switched depending on whether the hall sensor 12 gets out of order.

By the configuration, the motor controller 24 receives the virtual hall signal from the micom 20 when the switch 22 is in the second state and directly receives the hall signal from the hall sensor 12 when the switch is switched from the second state to the first state.

That is, when the micom 12 receives the normal hall signal from the hall sensor 12, as illustrated in FIG. 1, the switches 22 are kept in the first state, and thus the motor controller 24 receives the hall signal only from the hall sensor 12. Therefore, the motor 10 may be normally driven. On the other hand, when the micom 20 receives the hall signal, which represents that at least one of the plurality of phases 12a, 12b, and 12c gets out of order, the switches 22 are in the second state as illustrated in FIG. 2, and thus the motor controller 24 may receive only the virtual hall signal from the micom 20. Therefore, the motor controller 24 may control the motor 10 to be smoothly driven based on the virtual hall signal.

Meanwhile, when detecting the failure of the hall sensor 12, the micom 20 outputs the virtual hall signal for the broken phase and the hall signal for the normal phase, among the plurality of phases 12a, 12b, and 12c.

That is, when it is diagnosed that the hall sensor 12 gets out of order, the motor controller 24 receives the virtual hall siyual for the broken phase from the micom 20 and also needs to receive the hall signal for the phase in the normal condition, and therefore receives the hall signal via the micom 20 to normally control the motor 10.

According to the apparatus for controlling a motor having the above structure, the motor controller receives the virtual hall signal using the micom only at the time of the failure of the hall sensor, and directly receives the hall signal through the hall sensor at the time of the normal condition. This thereby reduces the delay time occurring due to the sharing of the micom at the time of the normal condition.

Although the present disclosure has been shown and described with respect to specific exemplary embodiments, it will be obvious to those skilled in the art that the present disclosure may be variously modified and altered without departing from the spirit and scope of the present disclosure as defined by the following claims.

What is claimed is:

1. An apparatus for controlling a motor, comprising:
a hall sensor including a plurality of phases, each phase provided to output hall siynals depending on a driving state of the motor;
a micom for detecting a failure of the hall sensor based on the hall signals and output virtual hall signals which are the hall signals in a normal condition depending on the detected results; and
a motor controller for receiving the hall signals from the hall sensor or the virtual hall signals from the micom and drive the motor depending on the received signal.

2. The apparatus of claim 1, further comprising:
a switch for keeping a first state in which the micom and the motor controller are disconnected from each other and the hall sensor and the motor controller are connected to each other,
wherein when detecting the failure of the hall sensor, the micom switches the switch from the first state to a second state in which the micom and the motor controller are connected to each other and the hall sensor and the motor controller are disconnected from each other.

3. The apparatus of claim 2, wherein the motor controller receives the virtual hall signal from the micom when the switch is in the second state and directly receives the hall signals from the hall sensor when the switch is in the first state.

4. The apparatus of claim 1, wherein when detecting the failure of the hall sensor, the micom outputs the virtual hall signal for a broken phase and the hall signal for a normal phase, among the plurality of phases.
